(19) United States
(12) Patent Application Publication
(10) Pub. No.: US 2023/0278002 A1
(43) Pub. Date: Sep. 7, 2023

(54) AUTOMATIC QUANTUM DOT MANUFACTURING APPARATUS AND AUTOMATIC QUANTUM DOT MANUFACTURING METHOD

(71) Applicant: LAMINAR CO., LTD., Seongnam-si (KR)

(72) Inventors: Jong Pal HONG, Seongnam-si (KR); Gyeong Rye CHOI, Seongnam-si (KR); Hee Jo JANG, Seongnam-si (KR)

(73) Assignee: LAMINAR CO., LTD., Seongnam-si (KR)

(21) Appl. No.: 18/118,690

(22) Filed: Mar. 7, 2023

(30) Foreign Application Priority Data
Mar. 7, 2022 (KR) 10-2022-0028529

(51) Int. Cl. B01J 19/24; C09K 11/70; C09K 11/08

(52) U.S. Cl. CPC B01J 19/245; B01J 19/2405; C09K 11/703; C09K 11/0883; B82Y 20/00

(57) ABSTRACT

The present invention relates to an automatic quantum dot manufacturing apparatus, which can automatically and/or continuously or semi-continuously manufacture quantum dots from a precursor by fluidly connecting a Taylor reactor for core synthesis, a Taylor reactor for shell synthesis, and a Taylor reactor for quantum dot washing to each other, and an automatic quantum dot manufacturing method using the same, in which the apparatus includes: a first Taylor reactor fluidly connected to a core precursor supply source; a second Taylor reactor fluidly connected to a shell precursor supply source and the first Taylor reactor; and a third Taylor reactor fluidly connected to a washing liquid supply source and the second Taylor reactor.

### TECHNICAL FIELD

The present invention relates to an automatic quantum dot manufacturing apparatus and an automatic quantum dot manufacturing method, and more specifically, to an automatic quantum dot manufacturing apparatus, which can automatically and/or continuously or semi-continuously manufacture quantum dots from a precursor by fluidly connecting a Taylor reactor for core synthesis, a Taylor reactor for shell synthesis, and a Taylor reactor for quantum dot washing to each other, and an automatic quantum dot manufacturing method using the same.

### BACKGROUND ART

A quantum dot refers to a metal or semiconductor crystal having a nanometer size, and generally includes several hundred to several thousand atoms. Since a team led by Professor Lewis Brus of the University of Columbia discovered colloidal quantum dots in the early 1980s and a team led by Professor Moungi Bawendi of MIT developed an efficient wet synthesis method in 1993, studies on quantum dots using various materials such as cadmium (Cd), indium (In), and lead (Pb) have been conducted. In general, quantum dots show intermediate properties between single atoms and bulk materials, and particularly, show properties in that a band-gap is inversely proportional to a size thereof due to a quantum confinement effect of electrons confined in a small space. An energy structure may be controlled without a change in a chemical composition by using the properties, and thus the quantum dots may be applied to various fields such as a solar cell, a light emitting device, a photocatalyst, a transistor, a sensor, and bioimaging.

Since the quantum dots are chemically synthesized inorganic materials, the quantum dots have advantages such as lower prices, longer lifespan, and higher color reproducibility than organic light emitting diodes (OLEDs) based on organic materials. Therefore, studies on technologies for manufacturing a photoelectric conversion device such as a solar cell and a light emitting diode using the quantum dots have been actively conducted.

The quantum dot consists of a core and a shell surrounding the core, and different colors may be implemented according to a size of the core. In general, when the size of the core is small, light having a short wavelength is generated to implement a color close to blue, and when the size of the core is large, light having a long wavelength is generated to implement a color close to red.

An element constituting the quantum dot, in particular, the core may be selected from various elements.

A composition of a group II-VI compound semiconductor including a group II element and group VI elements in the periodic table is used, and the quantum dots using the composition may emit light of a visible band with high light emitting efficiency and light stability, various studies on the quantum dots have been conducted until now.

However, there are many difficulties in mass-producing the quantum dots industrially. For example, one of the factors that greatly affects properties of quantum dots is a diameter of quantum dots, and according to a solution reaction method, which is currently known as a main manufacturing method of quantum dots, it is difficult to uniformly control the diameter of quantum dots in mass production.

Conventional manufacturing methods of quantum dots may include, for example, a hot injection method, a microflow reaction method, a one-pot synthesis method, a heating-up method, and a microfluidic reaction method.

First: Hot Injection Method

This method is currently the most general method for synthesizing quantum dots, and is a method for synthesizing quantum dots by injecting or heating a quantum dot precursor at a high temperature using a batch reaction system (single reaction vessel). However, since it is difficult to minutely control a reaction temperature and a reaction time in the batch-type hot injection method, it is difficult to form quantum dots having a constant size and high crystallinity. In particular, when scale-up is performed in the synthesis of quantum dots, if a relatively large amount of quantum dots is injected at a high temperature, a range of temperature changes may be increased and the reaction time may be hardly controlled, and thus it is difficult to manufacture a quantum dot having a desired wavelength band. Particularly, as a reaction capacity is increased, intensity of stirring becomes weak, so that it is difficult to uniformly form particles, and there is a tendency to cause a problem in that full width at half maximum (FWHM) increases. The FWHM means a difference between wavelengths having a light emission intensity value corresponding to half of the maximum light emission intensity on a light emission spectrum, and the narrower the FWHM, the higher the color purity may be implemented. Therefore, the increase in the FWHM causes a decrease in color purity.

Second: Microflow Reaction Method

This method suggests synthesis of quantum dots using a microflow reactor manufactured by Maeda group of AIST, Japan. The method was proposed as a method for inducing uniform generation of particles at a high temperature by forming a wide reaction surface area while allowing a reaction solution to rapidly passing through a capillary tube, and the method has an advantage in that the continuous work is possible, but also has a disadvantage in that initial costs are relatively high because it does not significantly deviate from a frame of the hot injection method.

Third: One-Pot Synthesis Method

This method was developed by NanoSquare Limited of Hong Kong, and is a step-by-step one-pot reaction through control of a decomposition temperature of precursors, in which different precursors are formed in initial indium or cadmium composite according to the type of ligands, and synthesis of quantum dots of 100 to 1,000 g is successful using different reaction activation energy according to the type of precursors, but reproducibility is not good.

Fourth: Heating-Up Method

The heating-up method is a method of heating the precursor up to a shell formation temperature by QD Vision, Inc. of the United States. This method is very advantageous in mass production processes in that cores and shells may be generated at a time through the method suggested by Nanosquare Limited, which has many similarities to reaction of precursors at each temperature. Since a continuous process may be applied with this method, a gradient core shell may be formed. However, the quantum dots synthesized by this method has a disadvantage in that stability with respect to moisture and oxygen, particularly, ultraviolet rays, is very low, and thus, it is not good for mixing resins for film formation.

Fifth: Microfluidic Reaction Method

This method was developed by the Advanced Nanotechnology Institute of KAIST, Korea, and is a method for synthesizing quantum dots using a microfluidic reactor. A plastic chip with high heat resistance and chemical resistance and a synthesis system were applied to form a core and a shell at the same time. However, a process of sequentially performing injection, mixing, and heating is required, so that the method is not suitable for mass production.

Korean Unexamined Patent Publication No. 10-2021-0075131 (entitled “Continuous manufacture of graphenic compound”) discloses a high throughput continuous or semi-continuous reactor and a method for manufacturing a graphenic material such as graphene using a Taylor reactor.

Korean Registered Patent No. 10-1424610 (entitled “Apparatus for manufacturing core-shell particles and method for manufacturing core-shell particles using the same) relates to an invention filed and registered by the present applicant, and discloses an apparatus for manufacturing core-shell particles, which is used for a positive electrode active material of a lithium secondary battery, preferably, core-shell particles in which a shell is formed in a core by injecting gas, liquid and/or solid materials in a state where a liquid solvent is present, and a method for manufacturing core-shell particles using the same.

Accordingly, there is still a need to develop new technologies for automatically mass-producing quantum dots.

### DISCLOSURE

### Technical Problem

An object of the present invention is to provide an automatic quantum dot manufacturing apparatus, which can automatically and/or continuously or semi-continuously manufacture quantum dots from a precursor by fluidly connecting a Taylor reactor for core synthesis, a Taylor reactor for shell synthesis, and a Taylor reactor for quantum dot washing to each other, and an automatic quantum dot manufacturing method using the same.

### Technical Solution

An automatic quantum dot manufacturing apparatus according to one embodiment of the present invention includes: a first Taylor reactor fluidly connected to a core precursor supply source; a second Taylor reactor fluidly connected to a shell precursor supply source and the first Taylor reactor; and a third Taylor reactor fluidly connected to a washing liquid supply source and the second Taylor reactor.

In the automatic quantum dot manufacturing apparatus, two or more second Taylor reactors may be continuously and fluidly connected between the first Taylor reactor and the third Taylor reactor.

An automatic quantum dot manufacturing method according to another embodiment of the present invention includes: (1) a core synthesis step of synthesizing a core by supplying a core precursor to a first Taylor reactor; (2) a shell synthesis step of synthesizing a shell on the core by supplying the core synthesized in the core synthesis step to a second Taylor reactor together with a shell precursor; and (3) a washing and precipitation step of performing a washing treatment on quantum dots manufactured in the shell synthesis step by supplying the quantum dots and a washing liquid to a third Taylor reactor, withdrawing the quantum dots from the third Taylor reactor, performing a pause, and performing solid-liquid separation and drying to obtain powdered quantum dots.

In the automatic quantum dot manufacturing method, the shell synthesis step may be performed twice or more in two or more second Taylor reactors that are continuously and fluidly connected.

### Advantageous Effects

According to the present invention, it is possible to provide an automatic quantum dot manufacturing apparatus, which can automatically and/or continuously or semi-continuously manufacture quantum dots from a precursor by fluidly connecting a Taylor reactor for core synthesis, a Taylor reactor for shell synthesis, and a Taylor reactor for quantum dot washing to each other, and an automatic quantum dot manufacturing method using the same, so that colloidal quantum dots and/or powdered quantum dots can be optionally, automatically, and continuously mass-produced.

### DESCRIPTION OF DRAWINGS

FIG. 1 is a view schematically showing a configuration of an automatic quantum dot manufacturing apparatus according to one embodiment of the present invention.

FIG. 2 is a view schematically showing a configuration of an automatic quantum dot manufacturing apparatus according to another embodiment of the present invention.

FIGS. 3(a) and 3(b) are photographs for testing precipitation of quantum dots, which are obtained from the automatic quantum dot manufacturing apparatus of the present invention, by pausing the quantum dots at room temperature and normal pressure, in which FIG. 3a is a photograph of a quantum dot product not subjected to a washing treatment, and FIG. 3b is a photograph of a quantum dot product subjected to a washing treatment after pausing for about 8 hours.

### MODE FOR INVENTION

Hereinafter, specific embodiments of the present invention will be described in detail with reference to the accompanying drawings.

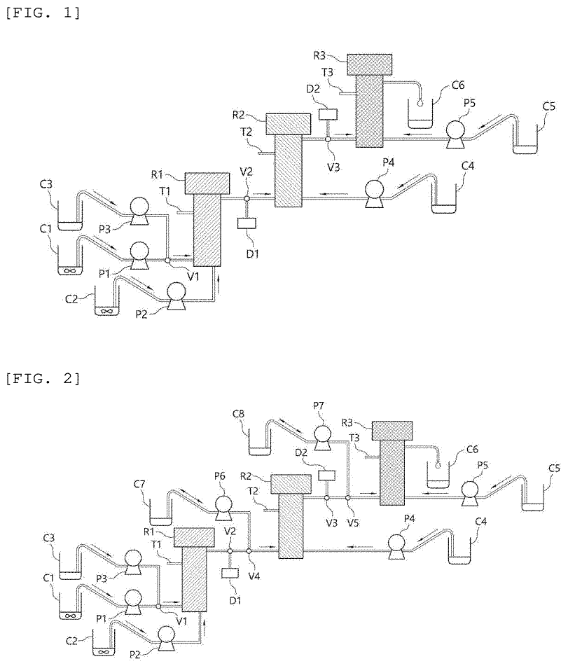

As shown in FIG. 1, an automatic quantum dot manufacturing apparatus according to one embodiment of the present invention includes: a first Taylor reactor fluidly connected to a core precursor supply source; a second Taylor reactor fluidly connected to a shell precursor supply source and the first Taylor reactor; and a third Taylor reactor fluidly connected to a washing liquid supply source and the second Taylor reactor. That is, an object of the present invention is to provide a manufacturing apparatus for continuously and automatically manufacturing quantum dots having a core-shell structure including both a core and a shell by using a plurality of Taylor reactors, and according to the present invention, the quantum dots may be continuously and automatically manufactured in a colloidal state where the quantum dots are dispersed in a medium and/or in a powder state where the medium is removed.

The first Taylor reactor is for synthesizing the core of the quantum dots having a core-shell structure from a core precursor. The core precursor may vary depending on quantum dots having a core-shell structure to be obtained. Basically, optical properties of the quantum dots, particularly, wavelengths of light emitted by the quantum dots depend on a size of the quantum dots, particularly, a size of the core of the quantum dots rather than a type of materials constituting the quantum dots. That is, as the size of the quantum dots increases, energy of a low energy region is absorbed or emitted, and thus a long-wavelength light emitting property (red color side of visible light) is exhibited. On the contrary, as the size of the quantum dots is reduced, energy of a high energy region is absorbed or emitted, and thus a short-wavelength light emitting property (purple light side of visible light) is exhibited.

As a material for quantum dots, in particular, as a material for a core, a composition of a group II-VI compound semiconductor including a group II element and group VI elements in the periodic table is used, and the quantum dots using the composition may emit light of a visible band with high light emitting efficiency and light stability, various studies on the quantum dots have been conducted until now. Studies on representative group II-VI compound semiconductor quantum dots have attracted much attention due to their advantages such as high light emitting efficiency and stability. The core in the quantum dots having a core-shell structure is preferably selected from the group consisting of CdS, CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, HgZnSTe, GaN, GaP, GaAs, GaSb, AlN, Alp, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, SnPbSTe, SiC, and SiGe, but is not intended to be limited thereto, and the core precursor may be a solution of compounds including raw materials capable of synthesizing the above core.

The first Taylor reactor is used to form a core in synthesis of quantum dots having a core-shell structure, and a flow in the Taylor reactor forms a so-called “Taylor vortex”, which may be defined as vortex cells periodically arranged along a cylindrical rotating body, or a fluid flow called a “Taylor vortex”. The Taylor's fluid flow was discovered by Couette in the early 1900s and was used as a viscometer for blood, and Taylor performed a fluid analysis using an equation in the mid-1990s. The term “Taylor's fluid flow” may be defined as a vortex formed when a fluid flows between two concentric cylinders and a fluid near the inner cylinder tends to move toward a fixed outer cylinder due to a centrifugal force as an inner cylinder rotates, and a fluid layer thus becomes unstable. Under certain conditions, such a vortex region appears when a rotation speed of the inner cylinder is greater than or equal to a threshold, each flow element consists of an annular vortex pair rotating in opposite directions, an axial length of each cell is equal to a distance between the inner cylinder and the outer cylinder, and thus the Taylor reactors may be simplified into a series of continuous tank reactors each having the same volume and the same residence time, and annular vortices may be considered similar to a continuous batch reactor. By using the Taylor vortex, the flow may be very regularly and uniformly mixed, and generally, the influence of a stirrer of the reactor may be excluded and a shear stress may be easily controlled. In the present invention, a Taylor reactor capable of forming such a Taylor vortex is used to form a core having a uniform particle size.

The first Taylor reactor may further include a temperature control unit for temperature control of a fluid passing through the inside of the reactor. For example, the temperature control unit may be a temperature-controllable unit such as a heating jacket or a band heater surrounding the outside of the reactor, in particular, a heating unit for synthesizing the core, but is not limited thereto. The heating jacket may allow a heat medium to pass through the inside of the jacket so as to heat the fluid passing through the inside of the reactor by heat conduction, and the band heater may be, for example, a ceramic band heater, in which the ceramic band heater is commercialized by leading domestic and foreign manufacturers, is used in a medium-temperature range of about 600° C. or lower, has a long lifespan and a high temperature in use, and is easily installed. The band heater is made of a metal inside, but the ceramic band heater is made of alumina ceramic fired at high temperature and high heat, has a cover that is mostly made of stainless steel, and is mainly used for a process for heating an extruder, an injection machine, and a cylinder.

The first Taylor reactor may further include a temperature measurement unit for confirming a temperature of the fluid passing through the inside of the reactor, in which the temperature control unit may be controlled based on the temperature measured by the temperature measurement unit to control a reaction temperature of the first Taylor reactor.

The first Taylor reactor may preferably be connected to an inert gas source, and may be an inert gas into the reactor, for example, nitrogen or argon, preferably nitrogen gas, and more preferably nitrogen gas from which moisture has been removed. This may prevent oxidation and fire occurrence of the core in the manufacture of quantum dots having a core-shell structure, particularly, during the manufacture of the core, and may allow the core to be synthesized under non-moisture and oxygen-free conditions, thereby increasing a synthesis yield of the core.

The core precursor supply source is a source for supplying the core precursor to the first Taylor reactor, in which the core precursor is a raw material of a material forming a core, which may be formed into core particles through the first Taylor reactor, and refers to a solution dissolved in a suitable solvent. Various components may be used as a raw material of the core forming core particles, and the same as or similar to those described above may be used as the raw material of the core.

The core synthesized in the first Taylor reactor has a crucial role in determining the optical properties of quantum dots according to the size of the core, and when the size of the core is small, light having a short wavelength is generated, and when the size of the core is large, light having a long wavelength is generated.

Important parameters in the synthesis of quantum dots, particularly, quantum dots having a core-shell structure, include a reaction temperature, a reaction concentration, a crystal plane, a type of ligands, and the like.

In particular, the ligand serves to increase dispersibility and efficiency of the core. That is, the ligand serves to maintain a specific distance without the agglomeration of numerous nanoparticles, so that dispersibility is improved, thereby preventing the agglomeration of the nanoparticles. In addition, the ligand serves to protect the core from an external environment and increase efficiency in the same and/or similar manner as the shell of the quantum dots having a core-shell structure. Such a ligand is well known to those skilled in the art, and it should be understood by those skilled in the art that a suitable ligand may be selected and used.

As in the present invention, the Taylor reactor is used, so that (1) a mass transfer rate is higher (about 3 times) than that of the existing tank-type reactor, (2) crystals may be easily self-assembled due to uniform mixing capability, thereby removing a dead-zone, and as a result, physical properties (purity, density, particle distribution, particle size, crystallinity, impurity removal rate, and the like) are improved, and a recovery rate may be increased, as compared to the existing reactor, (3) when scale-up is carried out with an ideal fluid flow without a dead zone, products having the same physical properties may be produced by controlling only a stirring speed, (4) the Taylor's fluid flow with strong stirring capability serves as a catalyst for reducing the reaction time (production time may be reduced by up to 20 times or as compared to the existing product), (5) the temperature control unit may be employed in a double-jacket, and thus it is possible to control a temperature from the outside, and particularly, because a reacted portion has a shape of a small tube, the temperature may be easily transferred and precisely controlled, such that it is possible to produce quantum dots having a uniform particle size with a narrow particle size distribution, and (6) conventional reactors process multiple steps using each apparatus, whereas the apparatus according to the present invention processes the multiple steps using one apparatus, that is, all-in-one type reactor, thereby continuously mass-producing the quantum dots.

One or more core precursor supply sources may be connected to the first Taylor reactor, and the number of core precursor supply sources connected to the first Taylor reactor may vary depending on the type of core. That is, in a case of one-component core synthesis, one core precursor supply source may be connected to the first Taylor reactor, in a case of two-component core synthesis, two core precursor supply sources may be connected to the first Taylor reactor, and in a case of three-component core synthesis, three core precursors may be connected to the first Taylor reactor.

A buffer supply source may be further connected to the first Taylor reactor. A buffer to be supplied to the first Taylor reactor by the buffer supply source may be supplied to the first Taylor reactor prior to supplying the core precursor to the first Taylor reactor so as to prefill the first Taylor reactor, and may allow the first Taylor reactor to be operated so as to form a Taylor vortex by the buffer, so that a Taylor vortex may be formed immediately after the subsequently supplied core precursor is supplied to the first Taylor reactor, thereby increasing synthesis efficiency of quantum dots.

The second Taylor reactor is for synthesizing the shell of the quantum dots having a core-shell structure from a shell precursor. The shell in the quantum dots having a core-shell structure may preferably be selected from the group consisting of ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AlP, and AlSb, but is not intended to be limited thereto, and the shell precursor may be a solution of compounds including raw materials capable of synthesizing the above shell.

The second Taylor reactor may be the same as and/or similar to the first Taylor reactor. That is, the second Taylor reactor is basically the same as the first Taylor reactor except that an outlet of the first Taylor reactor and the shell precursor supply source are connected to the second Taylor reactor, as compared to the first Taylor reactor in which the core precursor supply source is connected to an inlet of the first Taylor reactor.

The second Taylor reactor may also be connected with a buffer supply source and/or an inert gas source, if necessary, in the same and/or similar manner as in the first Taylor reactor.

The second Taylor reactor may further include a temperature control unit and/or a temperature measurement unit that is the same as and/or similar to the temperature control unit and/or the temperature measurement unit that may be installed in the first Taylor reactor.

The second Taylor reactor may be formed such that a plurality of shell layers are stacked on the core by connecting the plurality of shell layers to each other in series as many as the predetermined number of shells to be formed in the quantum dots having a core-shell structure.

The third Taylor reactor has a core-shell structure obtained from the second Taylor reactor, and is for manufacturing the quantum dots obtained in a colloid phase as a solid powder. That is, colloidal quantum dots obtained in the second Taylor reactor are not precipitated by only pausing the quantum dots at room temperature and normal pressure, and thus, in order to obtain the quantum dots as a powder, a separate high-speed centrifugal separator has to be used in the related art. However, in the present invention, the colloidal quantum dots withdrawn from the second Taylor reactor are supplied to the third Taylor reactor together with the washing liquid, an inner rotating body of the third Taylor reactor is rotated to apply the colloidal quantum dots and the washing liquid to the Taylor vortex, the colloidal quantum dots and the washing liquid are withdrawn from the third Taylor reactor, the quantum dots are precipitated by being simply paused at room temperature and normal pressure in a subsequent processing process, and then solid-liquid separation and drying are performed, thereby obtaining powdered quantum dots.

The third Taylor reactor may be the same as and/or similar to the first Taylor reactor. That is, the third Taylor reactor is basically the same as the first Taylor reactor except that an outlet of the second Taylor reactor and the washing liquid supply source are connected to the third Taylor reactor, as compared to the first Taylor reactor in which the core precursor is connected to the inlet of the first Taylor reactor.

The third Taylor reactor may further include a temperature control unit and/or a temperature measurement unit that is the same as and/or similar to the temperature control unit and/or the temperature measurement unit that may be installed in the first Taylor reactor.

The third Taylor reactor may also be connected with a buffer supply source and/or an inert gas source, if necessary, in the same and/or similar manner as in the first Taylor reactor.

The washing liquid is not particularly limited, and may be selected from among aqueous and/or non-aqueous solvents. For example, the washing liquid may be selected from the group consisting of alcohol-based, aliphatic hydrocarbon-based, alicyclic hydrocarbon-based, aromatic-based, halogenated hydrocarbon-based, aldehyde-based, ketone-based, ether-based, ester-based, nitrile-based, sulfoxide-based solvents or a mixture of two or more thereof, but it should be understood that the present invention is not limited thereto.

The alcohol-based solvent may include an alcohol-based compound having 1 to 10 carbon atoms, for example, methanol, ethanol, propanol, butanol, pentanol, or hexanol.

The aliphatic hydrocarbon-based solvent may include a hydrocarbon-based compound having 6 to 20 carbon atoms, for example, hexane, heptane, octane, nonane, or dodecane.

The alicyclic hydrocarbon-based solvent may include a cyclic hydrocarbon-based compound having 6 to 20 carbon atoms, for example, cyclohexane, cycloheptane, or cyclooctane.

The aromatic solvent may include an aromatic compound having 6 to 20 carbon atoms, for example, benzene, toluene, xylene, or pyridine.

The halogenated hydrocarbon-based solvent may include a hydrocarbon-based compound having 1 to 20 carbon atoms and substituted with one or more halogen elements among halogen elements of fluorine (F), chlorine (Cl), bromine (Br), and iodine (I), for example, chloroform or dichloromethane.

The aldehyde-based solvent may include a compound including at least one aldehyde group (R—C(O)—H), for example, dimethylformamide (DMF).

The ketone-based solvent may include a compound including at least one ketone group (R—C(O)—R′), for example, acetone or cyclohexanone.

The ether-based solvent may include a compound including at least one ether group (R—O—R′), for example, tetrahydrofuran.

The ester-based solvent may include a compound including at least one ester group (R—C(O)—OR′), for example, ethyl acetate.

The nitrile-based solvent may include a compound including at least one nitrile group (—CN), for example, benzonitrile or acetonitrile.

The sulfoxide-based solvent may include a compound including at least one sulfoxide group (R—S(O)—R′), for example, dimethylsulfoxide (DMSO).

A photoluminescent (PL) sensor for detecting formation of the core may be further provided between the first Taylor reactor and the second Taylor reactor. As the PL sensor, for example, a trade name “FLAME-T-VIS-NIR-ES” manufactured by Ocean Insight (formerly Ocean Optics), U.S.A., may be used, but it should be understood that the present invention is not intended to be limited thereto. The PL sensor may determine synthesis of the core by measuring a light emission wavelength band of the core, and when synthesis of a predetermined core is confirmed by the PL sensor, the core withdrawn from the first Taylor reactor may be supplied to the second Taylor reactor together with the shell precursor.

A PL sensor for detecting formation of the shell may be further provided between the second Taylor reactor and the third Taylor reactor. The PL sensor may be the same as and/or similar to the PL sensor positioned between the first Taylor reactor and the second Taylor reactor, and the PL sensor may determine synthesis of the shell by measuring the FWHM of the shell, and when synthesis of a predetermined shell is confirmed by the PL sensor, the quantum dots having a core-shell structure withdrawn from the second Taylor reactor may be supplied to the third Taylor reactor together with the washing liquid.

The PL sensor positioned between the first Taylor reactor and the second Taylor reactor is the same as the PL sensor positioned between the second Taylor reactor and the third Taylor reactor, preferably, one PL sensor may be connected between the first Taylor reactor and the second Taylor reactor and between the second Taylor reactor and the third Taylor reactor through a conduit for fluid connection, and more preferably, two PL sensors may be connected between the first Taylor reactor and the second Taylor reactor and between the second Taylor reactor and the third Taylor reactor, respectively.

The core precursor supply source may include a core precursor storage tank and a quantitative supply pump capable of quantitatively discharging a liquid core precursor. The shell precursor storage tank may be a storage tank storing the shell precursor dissolved in a suitable solvent, and preferably, may further include a stirring unit for dissolving the solid core precursor in a suitable solvent. The quantitative supply pump may be understood as a unit for supplying the liquid core precursor into the first Taylor reactor at a constant speed.

The shell precursor supply source may include a shell precursor storage tank and a quantitative supply pump capable of quantitatively discharging a liquid shell precursor. The shell precursor storage tank may be a storage tank storing the shell precursor dissolved in a suitable solvent, and preferably, may further include a stirring unit for dissolving a solid shell precursor in a suitable solvent.

The automatic quantum dot manufacturing apparatus may further include an immersion tank fluidly connected to an outlet of the third Taylor reactor. The immersion tank may pause the quantum dots withdrawn from the third Taylor reactor, preferably, may pause the quantum dots at room temperature and normal pressure, to immerse the solid quantum dots from colloids including the quantum dots and to separate the solid quantum dots through subsequent solid-liquid separation.

The automatic quantum dot manufacturing apparatus may further include a solid-liquid separation unit, which is a unit for separating the quantum dots which are withdrawn from the third Taylor reactor or are solid-liquid separated from the immersion tank. As the solid-liquid separation unit, it may be understood that various units known to those skilled in the art may be used, and examples thereof include a decanter, a separate funnel, a filter, a centrifugal separator, and an evaporator, but the present invention is not limited thereto.

The automatic quantum dot manufacturing apparatus may further include a drying unit, if necessary, and the drying unit functions to remove a liquid remaining in the solid quantum dots after solid-liquid separation.

In addition, the automatic quantum dot manufacturing apparatus according to the present invention may further include a control device, in which the control device may be a controller, for example, a programmable logic controller (PLC) or a microprocessor, which is electrically connected to the first Taylor reactor, the second Taylor reactor, and the third Taylor reactors to control operations of the reactors (for example, the rotation time and rotation speed of a rotating body that is rotatably fixed in a hollow body of the Taylor reactor); to control an operation (the rotation time and rotation speed of the pump) of the quantitative supply pump of the core precursor supply source and the quantitative supply pump of the shell precursor supply source; to control the temperature control unit and/or the temperature measurement unit installed in the Taylor reactors; and to control of the PL sensor(s).

FIG. 1 schematically shows an automatic quantum dot manufacturing apparatus according to one embodiment of the present invention. As shown in FIG. 1, the automatic quantum dot manufacturing apparatus according to the present invention is an example of a configuration for manufacturing quantum dots having a core-shell structure, for example, quantum dots having a core-shell structure with a two-component core and a two-component shell, including CdSe as the core and ZnS as the shell or including InP as the core and ZnS as the shell.

Referring to FIG. 1, the automatic quantum dot manufacturing apparatus includes a first Taylor reactor R1 for synthesizing a core, a second Taylor reactor R2 for synthesizing a shell, and a third Taylor reactor R3 for washing obtained quantum dots, the first Taylor reactor R1, the second Taylor reactor R2, and the third Taylor reactor R3 being fluidly connected to each other, in which a first core precursor storage tank C1 is fluidly connected to one of a plurality of inlets of the first Taylor reactor R1 through a first quantitative supply pump P1 as a first core precursor supply source, a second core precursor storage tank C2 is fluidly connected to the other inlet through a second quantitative supply pump P2 as a second core precursor supply source, and the second Taylor reactor R2 is also fluidly connected to an outlet of the first Taylor reactor R1. In addition, a buffer storage tank C3 may be connected to the first Taylor reactor R1 through a third quantitative supply pump P3 as a buffer supply source for filling the Taylor reactor with a buffer before supplying the core precursor. The buffer supply source may be directly connected through another inlet of the first Taylor reactor R1, but may be alternatively connected to a conduit for fluidly connecting the first core precursor supply source and the first Taylor reactor R1 through a flow control unit such as a three-way valve V1 so as to supply the buffer to the first Taylor reactor R1. In addition, the first Taylor reactor R1 may further include a temperature control unit (not shown for simplification of drawings) and/or a temperature measurement unit T1.

A shell precursor storage tank C4 is fluidly connected to one of a plurality of inlets of the second Taylor reactor R2 through a fourth quantitative supply pump P4 as a shell precursor supply source, the outlet of the first Taylor reactor R1 is fluidly connected to the other inlet, and the third Taylor reactor R3 is also fluidly connected to the outlet of the second Taylor reactor R2. In addition, a buffer supply source (not shown for simplification of drawings) for filling the Taylor reactor with a buffer may be further connected to the second Taylor reactor R2 before supplying the shell precursor, but it may be understood that the buffer supplied from the buffer supply source connected to the first Taylor reactor R1 may be supplied to the second Taylor reactor R2 through the first Taylor reactor R1. In addition, the second Taylor reactor R2 may further include a temperature control unit (not shown for simplification of drawings) and/or a temperature measurement unit T2.

A PL sensor D1 may be fluidly connected between the first Taylor reactor R1 and the second Taylor reactor R2 through a flow control unit, for example, a three-way valve V2, installed on the conduit for connecting the first Taylor reactor R1 and the second Taylor reactor R2.

A washing liquid storage tank C5 is fluidly connected to one of a plurality of inlets of the third Taylor reactor R3 through a fifth quantitative supply pump P5 as a washing liquid supply source, the outlet of the second Taylor reactor R2 is fluidly connected to the other inlet, and a quantum dot storage tank C6 for storing the manufactured quantum dots is also fluidly connected to the outlet of the third Taylor reactor R3. In addition, a buffer supply source (not shown for simplification of drawings) for filling the Taylor reactor with a buffer may be further connected to the third Taylor reactor R3 before supplying the washing liquid, but it may be understood that the buffer supplied from the buffer supply source connected to the first Taylor reactor R1 may be supplied to the third Taylor reactor R3 through the first Taylor reactor R1 and the second Taylor reactor R2. In addition, the third Taylor reactor R3 may further include a temperature control unit (not shown for simplification of drawings) and/or a temperature measurement unit T3.

A PL sensor D2 may be fluidly connected between the second Taylor reactor R2 and the third Taylor reactor R3 through a flow control unit, for example, a three-way valve V3, installed on the conduit for connecting the second Taylor reactor R2 and the third Taylor reactor R3.

It will be understood that the PL sensors D1 and D2 may be the same as and/or similar to each other, or may use one PL sensor.

In the automatic quantum dot manufacturing apparatus, two or more second Taylor reactors may be continuously and fluidly connected between the first Taylor reactor and the third Taylor reactor.

As shown in FIG. 2, the automatic quantum dot manufacturing apparatus may further include a core storage tank C7 between the first Taylor reactor R1 and the second Taylor reactor R2, in which the core storage tank C7 functions to temporarily store the core withdrawn from the first Taylor reactor R1 before the core is introduced into the second Taylor reactor R2, and to subsequently introduce the stored core into the second Taylor reactor R2 if necessary, and thus it is possible to constantly and continuously manufacture quantum dots even when an operation time of the first Taylor reactor R1 is different from an operation time of the second Taylor reactor R2. The core storage tank C7 may be fluidly connected through a conduit for fluidly connecting the first Taylor reactor R1 and the second Taylor reactor R2 or the PL sensor D1 and the second Taylor reactor R2, preferably through a flow control unit installed on the conduit, for example, a three-way valve V4, and through a sixth quantitative supply pump P6, if necessary, and the sixth quantitative supply pump P6 may be selectively operated, if necessary. For example, when the core synthesized in the first Taylor reactor R1 is withdrawn from the first Taylor reactor R1, the core may be supplied to and stored in the core storage tank C7 by an operating pressure of the first Taylor reactor R1, and when the core is supplied from the core storage tank C7 to the second Taylor reactor R2, the sixth quantitative supply pump P6 may be operated to supply the core to the second Taylor reactor R2.

Alternatively, instead of using the core storage tank C7 as described above, the first Taylor reactor R1 and the second Taylor reactor R2 may be of different capacities. That is, when there is a large difference between the synthesis time of the core and the synthesis time of the shell, Taylor reactors having a capacity in proportional to the synthesis time may be used. For example, when the synthesis time of the core is 2 minutes and the synthesis time of the shell is 10 minutes, the first Taylor reactor R1 for the synthesis of the core may be manufactured to have a capacity of 2 l, and the second Taylor reactor R2 for the synthesis of the shell may be manufactured to have a capacity of 10 l.

As shown in FIG. 2, the automatic quantum dot manufacturing apparatus may further include a quantum dot temporary storage tank C8 between the second Taylor reactor R2 and the third Taylor reactor R3, in which the quantum dot temporary storage tank C8 functions to temporarily store the quantum dots withdrawn from the second Taylor reactor R2 before the quantum dots are introduced into the third Taylor reactor R3, and to subsequently introduce the stored quantum dots into the third Taylor reactor R3 if necessary, and thus it is possible to constantly and continuously wash quantum dots even when an operation time of the second Taylor reactor R2 is different from an operation time of the third Taylor reactor R3. The quantum dot temporary storage tank C8 may be fluidly connected through a conduit for fluidly connecting the second Taylor reactor R2 and the third Taylor reactor R3 or the PL sensor D2 and the third Taylor reactor R3, preferably through a flow control unit installed on the conduit, for example, a three-way valve V5, and through a seventh quantitative supply pump P7, if necessary, and the seventh quantitative supply pump P7 may be selectively operated, if necessary. For example, when the quantum dots synthesized in the second Taylor reactor R2 is withdrawn from the second Taylor reactor R2, the quantum dots may be supplied to and stored in the quantum dot temporary storage tank C8 by the operating pressure of the second Taylor reactor R2, and when the quantum dots are supplied from the quantum dot temporary storage tank C8 to the third Taylor reactor R3, the seventh quantitative supply pump P7 may be operated to supply the core to the third Taylor reactor R3.

As described above, instead of using the quantum dot temporary storage tank C8, the second Taylor tank R2 and third Taylor reactor R3 may be of different capacities. That is, when there is a large difference between the synthesis time of the shell and the washing time of the quantum dots, Taylor reactors having a capacity in proportional to the synthesis time and/or the washing time may be used. For example, when the synthesis time of the shell is 10 minutes and the washing time of the quantum dots is 5 minutes, the second Taylor reactor R2 for synthesizing the shell may be manufactured to have a capacity of 10 l and the third Taylor reactor R3 for synthesizing the quantum dots may be manufactured to have a capacity of 5 l.

In addition, it will be understood that the Taylor reactors may further include a flow rate measurement unit at each inlet.

Both colloidal quantum dots and solid quantum dots according to the present invention, which have the configurations as described above, may be obtained. That is, the quantum dots withdrawn from the second Taylor reactor are stable colloidal quantum dots and may be stored, distributed, and used as it is in a colloid phase, and alternatively, the quantum dots withdrawn from the third Taylor reactor may be subsequently stored, distributed, and used in a powder state as a completely dried powder, that is, solid quantum dots, through a pause, solid-liquid separation, and drying. In this case, it will be understood by those skilled in the art that the quantum dots may be used as prepared in a colloid phase and other states by dispersing the quantum dots in a suitable medium again, if necessary.

An automatic quantum dot manufacturing method according to another embodiment of the present invention includes: (1) a core synthesis step of synthesizing a core by supplying a core precursor to a first Taylor reactor; (2) a shell synthesis step of synthesizing a shell on the core by supplying the core synthesized in the core synthesis step to a second Taylor reactor together with a shell precursor; and (3) a washing and precipitation step of performing a washing treatment on quantum dots manufactured in the shell synthesis step by supplying the quantum dots and a washing liquid to a third Taylor reactor, withdrawing the quantum dots from the third Taylor reactor, performing a pause, and performing solid-liquid separation and drying to obtain powdered quantum dots.

The core synthesis step of (1) is performed by supplying the core precursor to the first Taylor reactor, rotating an inner rotating body of the first Taylor reactor to form a Taylor vortex, and synthesizing a core of quantum dots having a core-shell structure from the core precursor by applying the core precursor for forming the core of the quantum dots to the Taylor vortex.

The shell synthesis step of (2) is performed by supplying the core synthesized in the core synthesis step to the second Taylor reactor together with the shell precursor, rotating an inner rotating body of the second Taylor reactor to form a Taylor vortex, and synthesizing quantum dots having a core-shell structure by applying the shell precursor for forming the shell of the quantum dots to the Taylor vortex together with the core and synthesizing the shell on a surface of the core.

The washing and precipitation step of (3) is performed by supplying the quantum dots having a core-shell structure manufactured in the shell synthesis step to the third Taylor reactor together with the washing liquid, rotating an inner rotating body of the third Taylor reactor to form a Taylor vortex, and allowing the quantum dots to be easily separated from a medium by applying colloids including the quantum dots having a core-shell structure to the Taylor vortex. The product washed in the washing and precipitation step described above may be withdrawn from the third Taylor reactor, and then may be solid-liquid separated by stationary pause, and thus solid-liquid separation and drying may be performed after the pause to obtain powdered solid quantum dots. In contrast, when the quantum dots having a core-shell structure formed in the shell forming step is not subjected to the washing and precipitation step through the washing and precipitation step, that is, the quantum dots withdrawn from the second Taylor reactor form a stable colloidal phase, solid-liquid separation is not performed even when the quantum dots are paused for at least 24 hours at room temperature and normal pressure, whereas the quantum dots withdrawn from the third Taylor reactor, that is, the quantum dots washed in the washing and precipitation step are paused at room temperature and normal pressure for about 5 to 10 hours to subject to solid-liquid separation, so that it is possible to obtain powdered solid quantum dots through a subsequent drying step.

In the automatic quantum dot manufacturing method, the shell synthesis step may be performed twice or more in two or more second Taylor reactors that are continuously and fluidly connected, thereby forming two types of shells on the core.

An example of synthesizing the quantum dots having a core-shell structure using the apparatus and the method according to the present invention as described above, will be described. Here, quantum dots having a core-shell structure including InP, which does not include a heavy metal, as a core, and InP/ZnS, which includes ZnS, as a shell, was manufactured. First, indium chloride, zinc iodide, and oleylamine (OLA) were put into a three-neck flask, and the three-neck flask was degassed at 120° C. for 20 minutes using a rotary pump to form a vacuum condition. Thereafter, nitrogen gas (N₂) was introduced into the flask to allow the flask to be substituted into a nitrogen atmosphere, and then the temperature was increased to 180° C. After indium and zinc were completely dissolved, the resultant was cooled to the room temperature in a nitrogen atmosphere. After cooling the resultant, a phosphorus precursor was injected into the three-neck flask and stirred for about 20 minutes to form an InP precursor (core precursor). The prepared precursor was put into the first Taylor reactor, a rotating body of the Taylor reactor was rotated to form a Taylor vortex, thereby forming a core of the core-shell quantum dot through temperature control (temperature increase). The formed core was put into the second Taylor reactor together with a shell precursor (ZnS precursor), and the rotating body of the Taylor reactor was rotated to form a Taylor vortex, thereby obtaining colloidal core-shell quantum dots through temperature control (temperature increase). The InP/ZnS quantum dots having a core-shell structure emitted light at 522 nm and had a full width at half maximum of 49 nm. Subsequently, the colloidal quantum dots were dispersed in toluene, and put into the third Taylor reactor together with an acetone-ethanol mixture (acetone:ethanol=4:1) as a washing liquid, and the rotating body of the Taylor reactor was rotated to form a Taylor vortex, thereby performing a washing treatment. Thereafter, the washed quantum dots withdrawn from the third Taylor reactor were paused at room temperature and normal pressure, and were dried after subjecting to solid-liquid separation, thereby obtaining quantum dots in a powder phase. In the quantum dot manufacture using the apparatus and method according to the present invention, continuous mass synthesis was possible and time and costs for manufacturing the quantum dots could be saved.

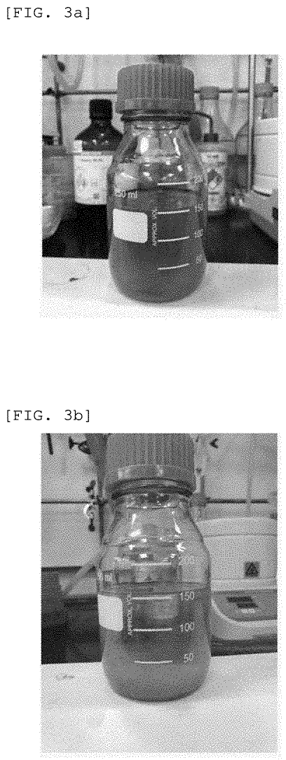

In particular, it could be confirmed that the stable colloidal quantum dots (before the washing treatment) withdrawn from the second Taylor reactor and the quantum dots after the washing treatment withdrawn from the third Taylor reactor showed a large difference as shown in FIG. 3 after the pause for about 8 hours at room temperature and atmospheric pressure. That is, it could be confirmed that precipitation did not occurred in the quantum dots before the washing treatment (FIG. 3a: quantum dots withdrawn from the second Taylor reactor) even during the pause at room temperature and normal pressure, whereas precipitation occurred in the quantum dots after the washing treatment (FIG. 3b: quantum dots withdrawn from the third Taylor reactor), thereby obtaining the quantum dots in a powder phase through the subsequent solid-liquid separation and drying.

Although the above-described detailed descriptions are described based on manufacture of quantum dots, it should be understood that the above-described detailed descriptions may be applied to the automatic manufacture of other particles.

Although the present invention has been described in detail only with respect to the disclosed embodiments, it is apparent to those skilled in the art that various modifications and variations may be made within the scope of the technical spirit of the present invention, and it is obvious that such modifications and variations are included in the appended claims.

### DESCRIPTION OF REFERENCE NUMERALS

C1: First core precursor storage tank C2: Second core precursor storage tank
C3: Buffer storage tank C4: Shell precursor storage tank
C5: Washing liquid storage tank C6: Quantum dot storage tank
C7: Core storage tank C8: Quantum dot temporary storage tank
D1: First PL sensor D2: Second PL Sensor
P1: First quantitative supply pump P2: Second quantitative supply pump
P3: Third quantitative supply pump P4: Fourth quantitative supply pump
P5: Fifth quantitative supply pump P6: Sixth quantitative supply pump
P7: Seventh quantitative supply pump R1: First Taylor reactor
R2: Second Taylor reactor R3: Third Taylor reactor
T1: Temperature measurement unit T2: Temperature measurement unit
T3: Temperature measurement unit V1: Three-way valve
V2: Three-way valve V3: three-way valve
V4: Three-way valve V5: Three-way valve

1. An automatic quantum dot manufacturing apparatus comprising: a first Taylor reactor fluidly connected to a core precursor supply source; a second Taylor reactor fluidly connected to a shell precursor supply source and the first Taylor reactor; and a third Taylor reactor fluidly connected to a washing liquid supply source and the second Taylor reactor.

2. The automatic quantum dot manufacturing apparatus of claim 1, wherein two or more second Taylor reactors are continuously and fluidly connected between the first Taylor reactor and the third Taylor reactor.

3. An automatic quantum dot manufacturing method comprising:
(a) a core synthesis step of synthesizing a core by supplying a core precursor to a first Taylor reactor;
(b) a shell synthesis step of synthesizing a shell on the core by supplying the core synthesized in the core synthesis step to a second Taylor reactor together with a shell precursor; and
(c) a washing and precipitation step of performing a washing treatment on quantum dots manufactured in the shell synthesis step by supplying the quantum dots to a third Taylor reactor together with a washing liquid, withdrawing the quantum dots from the third Taylor reactor, performing a pause, and performing solid-liquid separation and drying to obtain powdered quantum dots.

4. The automatic quantum dot manufacturing method of claim 3, wherein the shell synthesis step is performed twice or more in two or more second Taylor reactors that are continuously and fluidly connected.
